(19) United States
(12) Patent Application Publication
(10) Pub. No.: US 2026/0217016 A1
(43) Pub. Date: Jul. 30, 2026

(54) DEVICE FOR PROCESSING SHEETS AND/OR WEBS

(71) Applicant: KOLBUS GROUP GMBH, Rahden (DE)

(72) Inventors: Waldemar Eirich, Espelkamp (DE); Christian Schmale, Rahden (DE)

(21) Appl. No.: 19/147,460

(22) PCT Filed: Nov. 29, 2023
(86) PCT No.: PCT/EP2023/083522

§ 371 Date: Jul. 11, 2025

(30) Foreign Application Priority Data
Jan. 13, 2023 (DE) 10 2023 100 754.8

(51) Int. Cl. B41F 13/34; B41F 1/32; B41F 5/24; B41F 13/008

(52) U.S. Cl. CPC B41F 13/34; B41F 1/32; B41F 5/24; B41F 13/008

(57) ABSTRACT

The invention relates to a device for processing sheets and/or webs by means of a pair of driven rollers forming a gap, wherein the gearing connected to the rollers has, in terms of changes to the gap formed by the rollers, a fixed gearwheel and a second gearwheel which moves together with one of the rollers and interacts with the fixed gearwheel, and wherein the center-to-center distance of these two gearwheels remains constant irrespective of changes to the gap.

### BACKGROUND

The present invention relates to a device for processing sheets and/or webs according to the preamble of claim 1 and to a method for processing sheets.

Devices having one or more pairs of interacting cylindrical rollers are known for processing sheets and/or webs. The rollers are aligned parallel to one another and collectively form a working gap. This working gap is dimensioned in accordance with the thickness of the material sheet or the web. The rollers are arranged transverse to a transport direction of the material to be processed.

The roller pair may comprise, for example, a working roller in the form of a printing cylinder or a cutting cylinder. The second roller frequently is a mating roller that merely counteracts a deflection of the sheet or the web and performs a transport function together with the working roller.

A precise adaptation of the working gap to properties of the material to be processed, e.g. its thickness and elasticity, is required for the function of the roller pair. Adjustment devices are known for this purpose.

In the case of a printing or shaping working roller, the phase position of at least the working cylinder should at the same time be preserved when the working gap is changed. This is vital, for example, in printing machines with multiple printing units or in combination with a rotary die cutter.

Devices that provide a spur gearing for driving at least the working cylinder are known for this purpose. In devices for processing rigid materials such as corrugated board, the working gaps are adjusted by displacing the rollers on a common side of the sheets or the web. In the case of double-sided processing by means of multiple roller pairs, this means that at least one working roller has to be displaced in order to adjust the gap.

In order to preserve the phase position of the working roller, a change of the center-to-center distance within a spur gearing stage of the drive is accepted. This solution is very simple in terms of its constructive design. On the other hand, the change of the working gap inevitably leads to changes of the gear back lash and therefore to an unsteadier operation of the device and increased wear. In addition, the adjustment range is set within very narrow limits.

### SUMMARY

The present invention therefore is based on the objective of developing a device that eliminate at least one of the above-described disadvantages of the prior art.

This objective is attained with a device according to claim 1. Advantageous enhancements of the invention are characterized by the features disclosed in the dependent claims.

The proposed device for processing sheets or webs has a tool pair. This tool pair is formed by a working roller and a mating roller. Both rollers are driven collectively. For this purpose, the device has a motor that is connected to the tool pair by means of a gearing. At least the working roller has a predetermined phase position in relation to a main shaft of the device, respectively a cycle shaft. In this case, it is not necessary that the main shaft exists physically. It may also be a virtual shaft that is mapped electronically.

The same motor may be connected to and drive other operational units of the device. These operational units likewise may have a predefined phase position in relation to the main shaft. This phase position may differ from that of the aforementioned working roller.

The rollers of the tool pair are aligned parallel to one another. Their rotational axes are oriented transverse to a transport direction of the material to be processed. The rollers are arranged relative to one another in such a way that they collectively form a working gap, through which the material to be processed is transported. This working gap can be adjusted to a predetermined dimension. This dimension is defined by the thickness and mechanical properties of the material to be processed, e.g. its elasticity.

The working roller is accommodated in an adjustment device in order to adjust the working gap. The adjusting direction is oriented radially to the working roller toward the rotational axis of its mating roller. The adjustment naturally can take place in both directions.

The drive of the working roller has three or more driving elements, the rotational axes of which respectively extend parallel to the working roller. For example, these driving elements may be gearwheels or belt pulleys. A first driving element is accommodated in the adjustment device together with the working roller. Its position moves with the working roller when the working gap is changed. A second driving element is mounted in an immovable position with respect to the change of the working gap.

A third driving element serves for producing the drive connection between the first and the second driving element. It is accommodated in a pivot arm. The pivoting axis of the arm with the third driving element either coincides with the rotational axis of the first driving element or with the rotational axis of the second driving element.

The center-to-center distance of the first driving element to the third driving element, as well as the center-to-center distance of the second driving element to the third driving element, is independent of the working gap of the roller pair and of its change. A first center-to-center distance is defined by the shape of the pivot arm. The second center-to-center distance is kept constant due to the pivoting movement of the arm. The driving elements therefore can be respectively designed for a constant center-to-center distance. In this way, the gear back lash can be kept low and, in particular, independent of the working gap. Improved product quality, as well as smoother operation and improved durability of the device, are thereby achieved.

A restricted guidance of the pivot arm is advantageous in this respect. In a first embodiment, the restricted guidance is achieved by means of a second arm. This second arm serves as coupler between the third driving element on the one side and the first or the second driving element, which does not form the pivoting axis of the first pivot arm, on the other side. In an alternative embodiment, the pivot arm has an arc-shaped guide. This guide describes a circular arc around the respective first or second driving element, which does not form the pivoting axis of the pivot arm.

The adjustment device is equipped with a controllable drive. This drive is connected to an electronic control of the device via a data link. This control receives information on the material to be processed and determines the required working gap based on the received information.

The phase position of the working cylinder in relation to the main shaft should not be changed by changes to the working gap. The preservation of the phase position particularly is necessary in case the device comprises one or more other processing units.

According to the invention, the device comprises a second adjustment device. This second adjustment device is functionally connected to the working roller and defines its phase position in relation to a physical or electronic main shaft of the device. This second adjustment device preferably comprises a controllable adjustment drive. This adjustment drive is connected to the electronic control of the device with the aid of a data transmission means.

A measuring device for determining the phase position of the working roller in relation to the main shaft is advantageously provided. The sensor of this measuring device is connected to the electronic control with the aid of a data transmission means. In this way, the control receives information on the actual instantaneous phase position. This makes it possible to actively control the phase position in interaction with the second adjustment device. Register errors can thereby be avoided.

The device preferably comprises a second measuring device. This second measuring device measures the width of the working gap. It has a sensor that measures the width of the working gap directly or in the form of a representation of the working gap. This representation can be generated by means of a cam switch. However, it is also possible to use data from the adjustment drive itself such that an additional sensor would not be required.

In an advantageous embodiment, the electronic control of the device is equipped with a data memory. Allocations of predefined phase positions to widths of the working gap or respective representations are stored in this data memory. In this way, the phase position of the working roller can be automatically updated during an adjustment of the working gap while preserving a permanent drive coupling and without affecting the gear back lash.

### BRIEF DESCRIPTION OF THE DRAWINGS

Exemplary embodiments of the invention are described below with reference to the figures, to which we refer with respect to all details that are not explicitly mentioned in the description. In these figures:

FIG. 1 shows a first embodiment of a roller pair with variable working gap in the form of a schematic representation;

FIG. 2 shows a second embodiment of a roller pair with variable working gap in the form of a schematic representation; and

FIG. 3 shows a flexographic printing unit in the form of a perspective representation.

### DETAILED DESCRIPTION

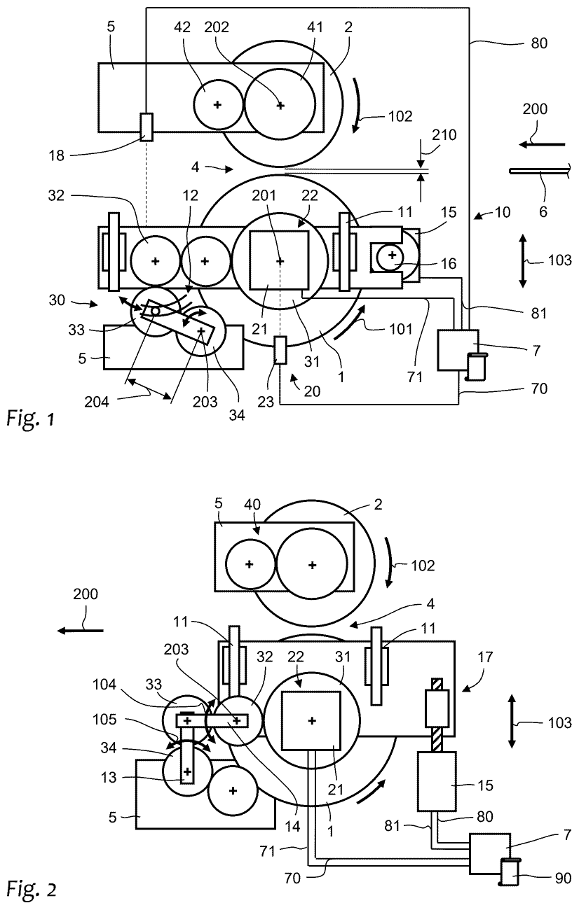

A first embodiment is schematically illustrated in FIG. 1. A mating roller 2 is arranged above a working roller 1 in this case. The working roller 1 is mounted so as to be rotatable about a first rotational axis 201 and the mating roller 2 is mounted so as to be rotatable about a second rotational axis 202. Both rotational axes 201, 202 are oriented parallel to one another. Both rollers 1, 2 collectively act upon a material sheet 6. A not-shown material web may also be processed instead of a sheet 6. The two rollers 1, 2 collectively form a working gap 4. The width of the working gap 4 is predetermined by the thickness of the material 6 to be processed.

The material 6 is moved through this working gap 4 in a horizontal transport direction 200 extending transverse to the rollers 1, 2. In the process, the working roller 1 rolls on the material 6 to be processed in a first rotary movement 101 and the mating roller 2 rolls on the material to be processed in a second rotary movement 102.

The mating roller 2 is accommodated in the machine frame 5 stationarily whereas the working roller 1 is mounted in an adjustment device 10. This adjustment device 10 defines a vertical adjusting direction 103 for the working roller 1. For this purpose, the adjustment device 10 is arranged so as to be movable relative to the machine frame 5 by means of linear guides 11. The adjustment device 10 is equipped with adjustment means in the form of a cam 16 that engages into a fork. This cam is actuated by an adjustment drive 15.

The adjustment device 10 comprises a sensor 18. This sensor measures a distance representing the width 210 of the working gap 4. The sensor 18 is connected to the control 7 of the device with the aid of a data transmission means in the form of a line 80. The adjustment drive 15 likewise is connected to the same control 7 with the aid of a data transmission means in the form of an additional line 81. This enables the control 7 to control the width 210 of the working gap 4 in accordance with a preselected target value.

The working roller 1 and its mating roller 2 are both driven by the same not-shown motor. Their rotating directions 101, 102 during processing are indicated in the figures. The drive connection comprises a plurality of spur gears 31, 32, 33, 34, 41, 42. A first set 30 of these spur gears serves for driving the working roller 1. This first set comprises multiple gearwheels 31, 32, 33, 34. In this case, a first spur gear 31 and a second spur gear 32, which is connected to the first spur gear by means of an intermediate gearwheel, are accommodated in the adjustment device 10 for the working gap 4 together with the working roller 1.

The second spur gear 32 meshes with a third gearwheel 33, wherein this third spur gear 33 is accommodated in an arm 13 that is pivotable about a rotational axis 203. The rotational axis 203 of this pivot arm 13 is arranged in the frame 5 of the device immovably with respect to the adjusting movement of the working gap 4. It coincides with the rotational axis of a fourth spur gear 34 that is rigidly mounted in the frame 5. This fourth spur gear 34 likewise meshes with the pivotably arranged third gearwheel 33.

The center-to-center distance of the first spur gear 31 to the second gearwheel 32 and the center-to-center distance 204 of the third gearwheel 33 to the fourth spur gear 34 are invariable due to their arrangement. The center-to-center distance of the second spur gear 32, which is moved together with the working roller 1, to the third spur gear 33 is also kept constant during the adjustment of the working gap 4 by means of a guide 12. This guide 12 imposes the movement pattern for the corresponding adjusting movement upon the arm 13 with the third gearwheel 33 mounted therein. This adjusting movement is carried out along an arc extending concentric to the second spur gear 32.

A second adjustment device 20 serves for adapting the phase position of the working roller 1 to a not-shown physical or electronically mapped main shaft of the device. It comprises an adjustment drive 21 that is functionally connected to the working roller 1 by means of a differential gear 22. The adjustment drive 21 is connected to the control 7 of the device with the aid of a data transmission means in the form of a line 71.

The correlation between the gap width 210 and the resulting deviation of the phase position is stored in a data memory 90 of the control 7. This mathematical function may be stored in the form of a table or in the form of an equation. In this way, the phase shift occurring as a result of the adjustment of the working gap 4 can be corrected.

Consequently, the working gap 4 can be adjusted without changing the phase position of the working roller 1 in relation to a physical or electronic main shaft of the device, namely even during ongoing processing by means of the roller pair 1, 2, while a permanent drive connection of the working roller 1 is preserved.

A sensor 23 that measures the phase position of the working roller 1 or a corresponding representation is alternatively or additionally provided. This sensor is connected to the same control 7 with the aid of a data transmission means in the form of a line 70. This allows an active control of the phase position to a preselected target value.

A second exemplary embodiment is illustrated in FIG. 2. In this case, a working roller 1 in the form of a printing cylinder interacts with a mating roller 2 in the form of an impression cylinder. Both rollers collectively form the printing gap 4. In contrast to the example illustrated in FIG. 1, the arc-shaped guide 12 of the pivot arm 13 is replaced with a second arm 14 in this case. The pivoting axis 203 of this second arm 14 coincides with the rotational axis of a spur gear 32, which with respect to the working gap 4 is moved together with the working roller 1.

Furthermore, the adjustment means of the adjustment device 10 for changing the working gap 4 is realized in the form of a spindle drive 17 instead of the above-described cam 16. No additional sensor for measuring the width 210 of the working gap 4 is provided. Instead, data returned from the adjustment drive 15 with the aid of the data transmission means 80 is used as representation of the gap with 210.

Information acquired from the adjustment drive 21 that changes the phase position likewise is used as representation of the actual phase position. This data is returned to the control 7 with the aid of a data transmission means 71. In this second example, it is possible to dispense with an additional sensor of the type described with reference to the preceding example without loss of functionality.

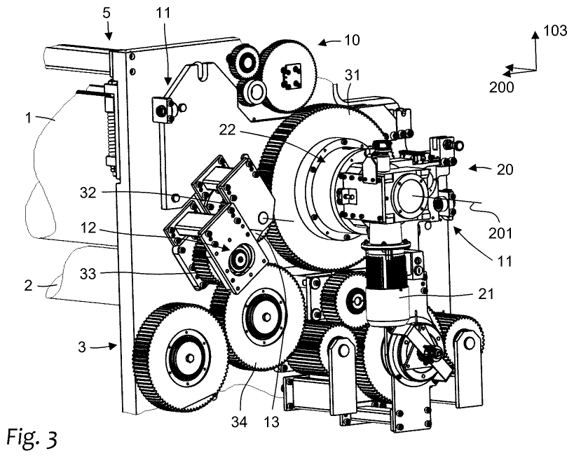

FIG. 3 shows another exemplary embodiment in the form of a section of a flexographic printing unit. It represents a variation of the first example illustrated in FIG. 1. The working roller 1 in the form of a printing cylinder 1 interacts with the mating roller 2 in the form of an impression cylinder. The printing cylinder 1 is arranged above the impression cylinder 2 in this case. They collectively form a printing gap 4. The printing cylinder 1 is accommodated in the machine frame 5 so as to be adjustable in the vertical direction 103 in order to adapt the printing gap 4 to the printing substrate.

The impression cylinder is mounted in the machine frame 5 stationarily whereas the printing cylinder 1 is accommodated in an adjustment device 10. This adjustment device 10 comprises linear guides 11. The linear guides 11 define a vertical adjusting direction 103 for the printing cylinder 1 that is rotatable about its axis 201. The adjustment is carried out with conventional means that are not illustrated in greater detail, e.g. spindles or cams.

The cylinders 1, 2 are driven by means of a gearing 3 that consists of a plurality of spur gear is 31, 32, 33, 34. In order to achieve a gear back lash that is independent of the width of the printing gap, all center-to-center distances of respectively intermeshing spur gears 31, 32, 33, 34 are constant with respect to the width of the printing gap.

An intermediate gearwheel 33 is provided for this purpose, wherein this intermediate gearwheel meshes with a spur gear 34 that is rigidly mounted in the frame, as well as with a spur gear 32 that can be vertically adjusted together with the printing cylinder 1. This intermediate gearwheel 33 is accommodated in a pivot arm 13. Contrary to the example illustrated in FIG. 1, the pivoting axis 203 according to FIG. 3 coincides with the rotational axis of the spur gear 32 that can be adjusted together with the printing cylinder 1.

The end of the pivot arm 13 that accommodates the intermediate gearwheel 33 is guided in a cam plate. An arc-shaped guide 12 is provided for this purpose. The connecting link of the arc-shaped guide 12 is arranged stationarily on the machine frame 5. A cam roller arranged concentric to the intermediate gearwheel 33 moves in the connecting link. The arc-shaped guide 12 is defined by a circular arc extending concentric to the spur gear 34, which is rigidly mounted in the frame and meshes with the intermediate gearwheel 33.

As a result, the intermediate gearwheel 33 moves along a concentric path around the spur gear 34 rigidly mounted in the frame as the width of the printing gap is changed. The center-to-center distance of the intermediate gearwheel 33 to the spur gear 34, which is rigidly mounted in the frame and meshes with said intermediate gearwheel, as well as the center-to-center distance of the intermediate gearwheel 33 to the spur gear 32, which can be adjusted together with the printing cylinder 1, remain constant irrespective of the width of the printing gap.

A change of the printing gap therefore would cause an undesirable change of the phase position of the printing cylinder 1 in relation to a main shaft of the entire machine. An additional adjustment device 20 is provided in order to compensate this undesirable change. The adjustment drive 21 of this additional adjustment device is connected to the printing cylinder 1 by means of a differential gear 22 in such a way that it is suitable for adjusting the phase position of the printing cylinder 1 in relation to a virtual main shaft of the machine to a predetermined value.

According to FIG. 2, the adjustment drive 21 for the phase position is connected to the machine control 7 with the aid of data transmission means 70, 71. A data line 71 is provided for transmitting control signals from the machine control 7. Another data line 70 returns information, which is obtained in the adjustment drive 21 and serves as representation of the phase position, to the control 7.

In this way, the phase position not only can be actively controlled to a predetermined value in the stationary operating mode. In fact, undesirable changes of the phase position, which are caused by the adjustment of the printing gap 4, are also compensated and the phase position is corrected accordingly. A loss of the desired phase position or the register accuracy as a result of intentional changes to the printing gap 4, e.g. for adapting the ink transfer from the printing cylinder 1 to the substrate 6, is also prevented during continuous production.

As an alternative to the described embodiments, the spur gears can also be replaced with belt drive pulleys.

### REFERENCE SYMBOLS

1 Working roller
2 Mating roller
3 Drive
4 Working gap
5 Machine frame
6 Material sheet
7 Control
10 Adjustment device
11 Linear guide
12 Curved guide
13 First Lever
14 Second Lever
15 Adjustment drive
16 Cam
17 Spindle drive
18 Sensor for gap width
20 Register adjustment
21 Adjustment drive for phase position
22 Differential gear
23 Sensor for phase position
30 Gearing of working roller
31 Spur gear
32 Downstream spur gear
33 Intermediate gearwheel
34 Upstream spur gear
35 Brake
37 Coupling
40 Gearing for mating roller
41 Spur gear
42 Spur gear
70 Data line
71 Data line
80 Data line
81 Data line
90 Data memory
101 Rotary movement of working roller
102 Rotary movement of mating roller
103 Adjusting movement for printing gap
104 Pivoting movement of arm
105 Rolling movement of intermediate gearwheel
200 Transport direction
201 Rotational axis of working roller
202 Rotational axis of mating roller
203 Pivoting axis
204 Center-to-center distance
210 Width of working gap

1. A device for processing substrates (6) in the form of sheets and/or webs such as paper, cardboard, corrugated board or similar materials, comprising at least
a working roller (1) that is rotatable about its axis (201), wherein the working roller (1) essentially extends transverse to a transport direction (200) of the substrate (6) to be processed,
a mating roller (2) that is assigned to and interacts with the at least one working roller (1) and is rotatable about its axis (202), wherein the mating roller (2) essentially is oriented parallel to the at least one assigned working roller (1) and the at least one mating roller (2) forms a working gap (4), through which the substrate (6) to be processed is transported in the transport direction (200), together with the at least one assigned working roller (1), and wherein the substrate (6) is processed at least by the working roller (1) in said working gap,
a drive with a motor and a gearing (30, 40), wherein the gearing (30, 40) produces a drive connection of the motor to the working roller (1) and to the mating roller (2),
a first adjustment device (10) that is assigned to the at least one working roller (1) and/or the at least one mating roller (2), wherein the at least one first adjustment device (10) is connected to the at least one working roller (1) and/or the at least one mating roller (2) in such a way that the at least one first adjustment device (10) is suitable for adjusting the working gap (4) between the working roller (1) and the mating roller (2) to a predetermined dimension (210),
a second adjustment device (20) that is assigned to the at least one working roller (1), wherein the second adjustment device (20) is connected to the working roller (1) in such a way that the at least one second adjustment device (20) is suitable for adjusting the phase position of the working roller (1) in relation to a physical and/or virtual main shaft of the device to a predetermined dimension, and
at least one controllable adjustment drive (21) of the second adjustment device (20) and by an electronic control (7), wherein the at least one adjustment drive (21) and the at least one control (7) are connected to one another with the aid of at least one first data transmission means (71).

2. The device according to claim 1, comprising at least one first measuring device (23) for measuring the phase position of the working roller (1), wherein the at least one first measuring device (23) is connected to the at least one control (7) of the at least one adjustment drive (21) with the aid of at least one second data transmission means (70).

3. The device of claim 1, comprising at least one second measuring device (18) for measuring the gap dimension (210) between the working roller (1) and the mating roller (2) corresponding thereto or a representation of this gap dimension (210), wherein the at least one second measuring device (18) is connected to the at least one control (7) with the aid of at least one third data transmission means (80).

4. The device of claim 1, wherein at least one data memory (90) is assigned to the at least one control (7), wherein a correlation between the phase position of the working cylinder (1) in relation to a physical and/or virtual main shaft of the device and the dimension of the working gap (210) is stored in said data memory, and wherein the correlation is stored in the data memory (90) in the form of a mathematical equation and/or in the form of a value table.
